(19) United States
(12) Patent Application Publication
(10) Pub. No.: US 2017/0363043 A1
(43) Pub. Date: Dec. 21, 2017

(54) GAS TURBINE ENGINE

(71) Applicant: ROLLS-ROYCE plc, London (GB)

(72) Inventor: Ahmad RAZAK, Bristol (GB)

(73) Assignee: ROLLS-ROYCE plc, London (GB)

(21) Appl. No.: 15/419,533

(22) Filed: Jan. 30, 2017

(30) Foreign Application Priority Data
Feb. 25, 2016 (GB) 1603254.2

(51) Int. Cl. F02K 3/10; F02C 9/18; F02C 3/04; F02C 7/36; F02K 3/11; F02K 3/075

(52) U.S. Cl. CPC F02K 3/10; F02K 3/11; F02K 3/075; F02C 3/04; F02C 7/36; F02C 9/18

(57) ABSTRACT

An aircraft gas turbine engine comprises a high pressure compressor driven by a high pressure turbine via a high pressure shaft, a first combustor provided downstream of the high pressure compressor and upstream of the high pressure turbine, a low pressure compressor driven by a low pressure turbine via a low pressure shaft, the low pressure compressor being configured to provide air to the high pressure compressor and to a bypass flow. The low pressure turbine comprises at least first and second turbine stages. The engine further comprises a second combustor provided downstream of the first stage of the low pressure turbine and upstream of the second stage of the low pressure turbine. The engine comprises a shaft coupling arrangement configured to transfer power between the high and low pressure shafts.

The present disclosure concerns a gas turbine engine having multiple combustion chambers

There is a continuing desire for gas turbine engines having improved specific fuel consumption (i.e. reduced fuel consumption for a given amount of thrust), to provide improved range, and reduced operating costs. This is particularly the case for aircraft which must operate over a wide range of speeds, such as supersonic aircraft. It is also desirable for gas turbine engines which operate at high speeds to have a high specific thrust (i.e. a high thrust for a given engine total intake air mass flow).

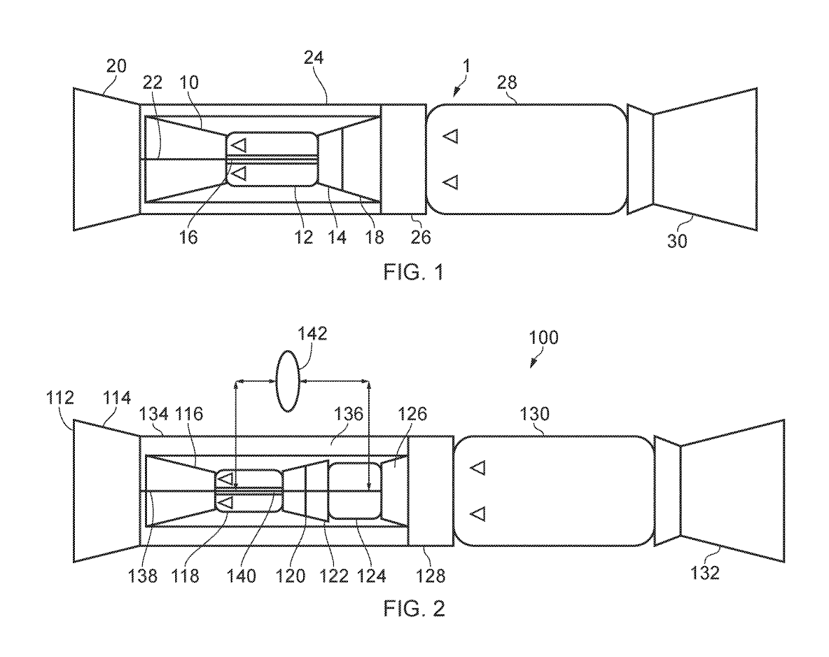

FIG. 1 shows a prior gas turbine engine 1 for a proposed supersonic business jet. The engine 1 comprises an engine core comprising a high pressure compressor 10, which supplies compressed air to a main combustor 12. Combustion products from the combustor 12 flow downstream in use to a high pressure turbine 14, which drives the high pressure compressor 10 via a shaft 16. Downstream of the high pressure turbine 14 is a low pressure turbine 18, which drives a low pressure compressor in the form of a fan 20 via a low pressure shaft 22. The fan 20 supercharges the core, and provides airflow through a bypass duct 24 which extends around the core. The bypass flow and core flow are combined in a mixer duct 26 located downstream of the low pressure turbine 18. A further combustor 28 (known as an afterburner or reheat combustor) is provided downstream of the mixer duct 26, which further raises the temperature and velocity of the exhaust. Air exits the engine through a nozzle 30, which may of convergent-divergent type, and typically has a variable area. The variable area is generally necessary to control backpressure on the turbines 14, 18 when the afterburner 28 is in operation.

Such an arrangement may have a relatively large length in view of the high velocity airflow within the afterburner, and the relatively long burn time of typical aviation fuels. Furthermore, such systems are relatively inefficient when the afterburner is in operation. Such engines typically have relatively low bypass ratios (i.e. the ratio between the core mass flow and bypass mass flow in use) of around 1:1 or less, so that they can operate efficiently at high speed (generally greater than Mach 1). However, such engines are consequently relatively inefficient at low speed (i.e. less than Mach 1) compared to engines having higher bypass ratios.

Consequently, there is a need to provide an aircraft gas turbine engine having high efficiency across a broad range of flight speeds.

In accordance with the present invention there is provided an aircraft gas turbine engine comprising a high pressure compressor driven by a high pressure turbine via a high pressure shaft, a first combustor provided downstream of the high pressure compressor and upstream of the high pressure turbine, a low pressure compressor driven by a low pressure turbine via a low pressure shaft, the low pressure compressor being configured to provide air to the high pressure compressor and to a bypass flow, the low pressure turbine comprising at least first and second turbine stages, and a second combustor provided downstream of the first stage of the low pressure turbine and upstream of the second stage of the low pressure turbine, wherein the gas turbine engine comprises a shaft coupling arrangement configured to transfer power between the high and low pressure shafts.

Advantageously, the arrangement provides a gas turbine engine having a high specific thrust and a low fuel consumption in view of the provision on a second combustor located between turbine stages of the low pressure turbine. Consequently, the specific thrust of the engine can be increased using the second combustor, while allowing for a relatively high bypass ratio, thereby providing high efficiency at both supersonic and subsonic speeds.

A bypass ratio is defined by a ratio of mass flow through the bypass to mass flow through high pressure compressor. The engine may comprise a bypass ratio greater than 1, and may comprise a bypass ratio of approximately 3. Due to the relatively high bypass ratio (compared to less than 1 for conventional high specific thrust aircraft gas turbine engines), the engine has a relatively low specific fuel consumption at subsonic speeds due to the improved propulsive efficiency achievable with a higher bypass ratio, and the ability to generate high thrust at high speeds without recourse to using an afterburner.

The low pressure compressor may comprise at least one fan stage configured to provide air to the high pressure compressor and the bypass, and at least one core stage configured to provide air to the high pressure compressor only.

The engine may comprise an afterburner provided downstream of the low pressure turbine in the core flow. Alternatively or in addition, the engine may comprise a duct burner located in the bypass, downstream of the low pressure compressor.

The engine may comprise a mixer configured to mix bypass and core flows downstream of the low pressure compressor and the low pressure turbine. The mixer may be provided upstream of the afterburner.

The engine may comprise a variable area exhaust nozzle downstream of the low pressure turbine.

The coupling arrangement may comprise a fluid coupling such as a torque converter comprising an input shaft coupled to the one of the high pressure shaft and the low pressure shaft and an output shaft coupled to the other shaft. Alternatively or in addition, the shaft coupling arrangement may comprise a mechanical clutch and/or a continuously variable transmission or a gearbox having a plurality of discrete ratios. The coupling arrangement may comprise an electric generator coupled to one of the high and low pressure shafts, and an electric motor coupled to the other shaft, the electric generator being electrically coupled to the electric motor to thereby drive the electric motor.

The fluid coupling may comprise a first rotor coupled to the input shaft and a second rotor coupled to the output shaft, the first and second rotors being immersed in a transmission fluid within a fluid coupling housing. The transmission fluid may comprise aviation fuel. The gas turbine engine may comprise a fuel system configured to provide fuel from a fuel tank to an engine injector via the fluid coupling housing. Advantageously, any heat generated due to transmission inefficiencies of the fluid coupling is transferred to the combustor and thereafter to the turbines, thereby increasing the thermodynamic efficiency of the arrangement.

The fluid coupling may comprise a stator immersed within the transmission fluid. One or more of the first and second rotor and the stator may comprise a bladed disc. One or more of the first and second rotor and the stator may comprise a variable pitch mechanism configured to vary the pitch of blades of the first or second rotor or stator. Consequently, power transmitted from the high pressure shaft to the low pressure shaft can be selectively varied.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

Embodiments will now be described by way of example only, with reference to the Figures, in which:

FIG. 1 is a schematic side view of a prior gas turbine engine;

FIG. 2 is a schematic side view of a first gas turbine engine in accordance with the present disclosure;

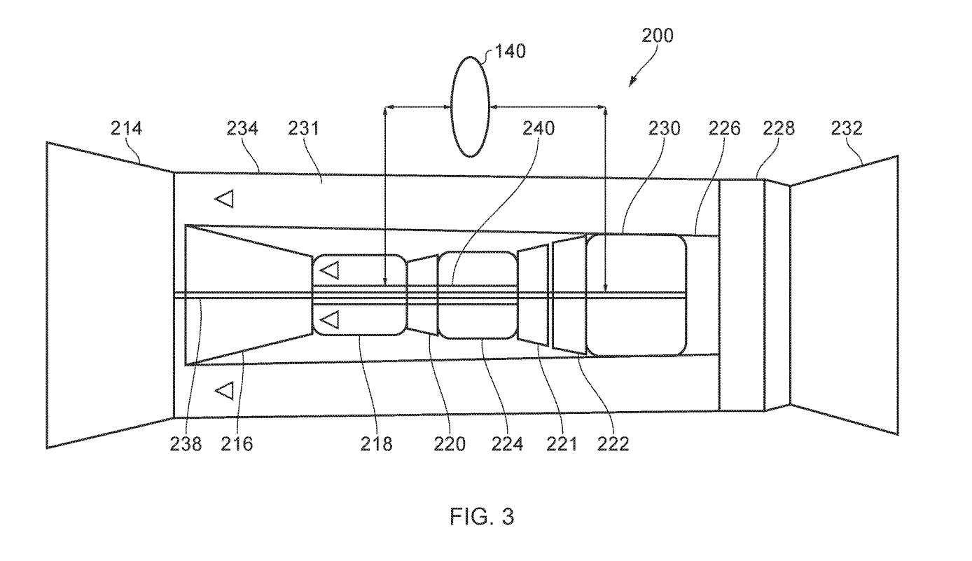

FIG. 3 is a schematic side view of a second gas turbine engine in accordance with the present disclosure;

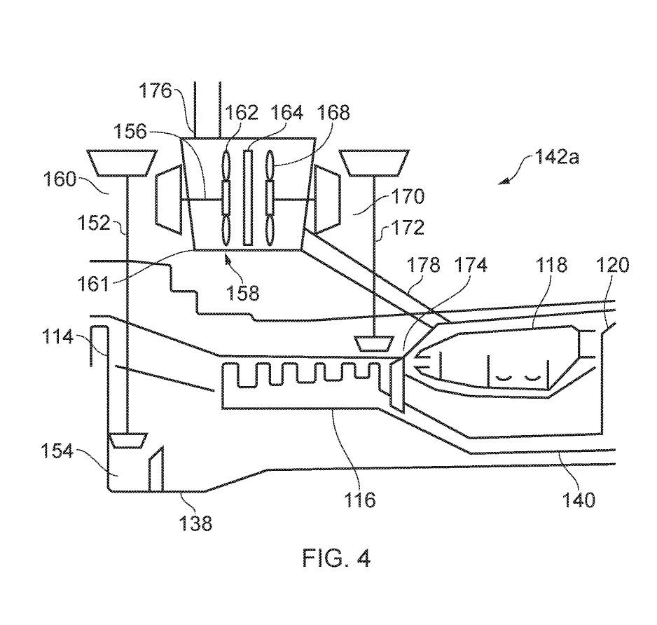

FIG. 4 is a schematic side view of a first shaft coupling arrangement suitable for use with the gas turbine engine of FIG. 2 or FIG. 3;

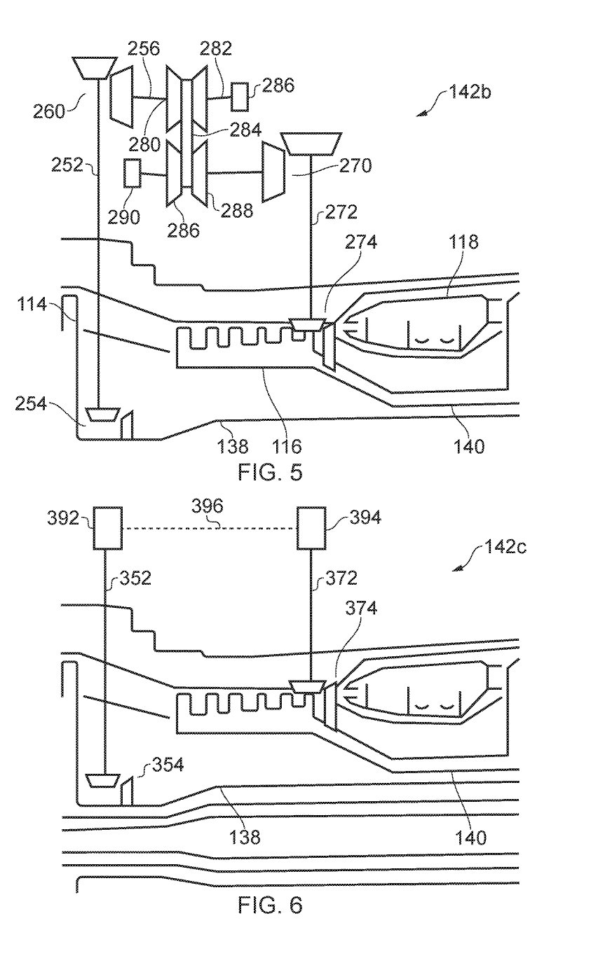

FIG. 5 is a schematic side view of a second shaft coupling arrangement suitable for use with the gas turbine engine of FIG. 2 or FIG. 3; and

FIG. 6 is a schematic side view of a third shaft coupling arrangement suitable for use with the gas turbine engine of FIG. 2 or FIG. 3.

With reference to FIG. 2, a gas turbine engine is generally indicated at 100. The engine 100 comprises, in axial flow series, an air intake 112, a propulsive fan 11, a high-pressure compressor 116, a first combustor 118, a high-pressure turbine 120, a first stage 122 of a low-pressure turbine, a second combustor 124, a second stage 126 of the low pressure turbine, a mixer 128, an afterburner 130, and an exhaust nozzle 132. A nacelle 134 generally surrounds the engine 100 and defines the intake 112, mixer, 128, afterburner 130, nozzle 132 and a bypass duct 136.

The fan 114 comprises a multi stage axial compressor comprising a plurality of rotors and stators of conventional construction, which is arranged to provide airflow to both the high pressure compressor 116 (i.e. the “core”) and the bypass passage 136. The fan 114 is coupled to both the first and second stages 122, 126 of the low pressure turbine, and is thereby driven, by a low pressure shaft 138. In some embodiments, the low pressure compressor 114 may further comprise a “booster compressor” driven by the low pressure shaft 138, which is configured to compress engine core air, and deliver compressed air to the high pressure stage 116 only, and not to the bypass duct 136. The booster compressor may comprise one or more stages, and may be of axial or centrifugal type. The fan 114 and compressor 116 are sized in the described embodiment such that the ratio of mass of flow air in the bypass flow relative to the air in the core flow (i.e. the bypass ratio) in use is approximately 3. More generally, the bypass ratio is likely to be greater than 1. In view of the relatively high bypass ratio, the engine is thought to provide efficiency savings during subsonic flight of up to 30%.

Similarly, the high pressure compressor 116 typically comprises a multi stage axial flow compressor comprising a plurality of rotor and stator stages (not shown). The high pressure compressor rotor 116 is coupled to the high pressure turbine 120 by a high pressure shaft 140.

The first combustor 118 comprises a substantially constant pressure combustor, which may be of conventional construction, such as a rich burn, lean burn or rich-quick-quench-lean burn (RQL) combustor. The first combustor 118 is configured to burn fuel with air delivered by the high pressure compressor 116, and deliver hot combustion products to the high pressure turbine 120.

The high pressure turbine 120 is provided downstream of the first combustor 118, and is configured to receive hot combustion gasses from the combustor 118, and expand those gasses to drive the high pressure compressor 116. The turbine may be of conventional construction, and typically consists of at least one turbine rotor (which may be of axial or radial type) and a turbine stator or diffusor. The turbine 122 may comprise one or more turbine stage.

The first stage 122 of the low pressure turbine 122 is provided downstream of the high pressure turbine 122, and again comprises at least one radial or axial flow rotor, and a stator or diffuser. Further low pressure turbine stages may optionally be provided upstream of the second combustor 124.

The second combustor 124 is provided downstream of the first stage of the low pressure turbine 122. The second combustor 124 is similar to the first combustor 118, being of a substantially constant pressure type.

The second stage of the low pressure turbine 126 is provided downstream of the second combustor 124, and again, is of conventional construction. Again, further turbine stages may be provided downstream.

The mixer 128 is provided downstream of the second stage of the low pressure turbine 126, and downstream of the bypass duct 136, such that the mixer 128 is configured to receive engine core exhaust from the turbine 126, and bypass exhaust from the fan 114. The flows are mixed together in this region prior to delivery to the afterburner 130.

The afterburner 130 is generally of a different construction to the first and second combustors 118, 124, in view of the relatively high velocity airflow through the afterburner, but again is of a known type suitable for use as an afterburner.

The exhaust nozzle 132 is of conventional construction, being of a convergent-divergent type, and having a variable area, such that the outlet area can be varied in dependence on operating conditions.

The engine 100 further comprises a shaft coupling arrangement 142 configured to couple the low and high pressure shafts 138, 140 together, to thereby selectively transfer power between the low and high pressure shafts, while allowing each shaft 138, 140 to rotate at a different speed, independently of the other shaft. It will be understood that any suitable mechanical, electrical, magnetic, hydraulic or pneumatic transmission means may be employed, providing the transmission is capable of selectively transferring power while permitting rotation of the low and high pressure shafts 138, 140 at different speeds.

FIG. 4 shows a first proposed coupling arrangement 142a. The coupling arrangement 142a comprises a radial drive shaft 152 driven by the low pressure shaft 138 via a first bevel gear arrangement 154. The radial drive shaft 154 is in turn coupled to an input shaft 156 of a torque converter 158 via a second bevel arrangement 160.

The torque converter 158 comprises a fluid filled housing 161 housing an input impeller 162 comprising a bladed rotor configured to impart swirl into the transmission fluid, a bladed stator 164 configured to control swirl of the transmission fluid, and an output turbine 168, configured to convert swirl of the transmission fluid to torque. The output turbine 168 is coupled to the high pressure shaft 140 via a third bevel arrangement 170, output radial drive 172 and fourth bevel arrangement 174.

In this embodiment, the transmission fluid comprises gas turbine engine fuel such as aviation fuel, and is transmitted to the housing 161 via a fuel supply conduit 176. A further fluid supply conduit 178 is provided, which extends between the housing 161 and the first combustor 118. Consequently, a continuous flow of aviation fuel is provided through the housing 161, which both provides a medium within which the rotors 162, 168 and stator 164 may operate, and cooling to dissipate heat generated by the swirling of the fluid. Since this fluid is then transferred to the combustor 118, the heat produced by the torque converter 158 is conserved within the thermodynamic cycle of the engine 100, and thus any inefficiency in the torque converter arrangement is at least partially recovered by the turbines 120, 122, 128. Consequently, the above arrangement provides a highly efficient system. The torque converter could also include a “lock-up” arrangement for mechanically locking the first and second shaft via a clutch, to thereby directly link the first and second shafts. One of the radial drives 152, 172 could be coupled to the respective shaft 138, 140 via gearing, which may increase or reduce the speed of the respective radial drive relative to the respective shaft.

FIG. 5 shows a first alternative coupling arrangement 142b. The arrangement 142b comprises a radial drive shaft 252 driven by the low pressure shaft 138 via a first bevel gear arrangement 254. The radial drive 252 is in turn coupled to an input shaft 256 of a continuously variable transmission arrangement (CVT) via a second bevel gear arrangement 260.

The CVT comprises first and second conical input rotors 280, 282 which are driven by the input shaft 256 and coupled to one another by a drive chain 284. A first actuator 286 varies the axial distance between the first and second rotors 280, 282 to thereby vary the effective outer diameter of the rotors 280, 282 where they engage with the chain 284, and so the input gearing of the CVT. The chain 284 also extends around third and fourth conical output rotors 286, 288, which are thereby rotated by the chain 284. The fourth rotor 288 is coupled to the high pressure shaft 140 via an output shaft, a third bevel arrangement 270, a second radial drive shaft 272 and a fourth bevel arrangement 274. The rotors 286, 288 are coupled to a second actuator 290 which again varies the axial distance between the conical rotors 286, 288 to thereby vary the output gearing of the CVT. In use, the actuators 286, 290 are operated synchronously, such that the gearing of the CVT can be continuously varied without introducing slack or excessive tension into the chain 284. Torque from the low pressure shaft 138 is thus transferable to the high pressure shaft 140 via the coupling arrangement 242b.

FIG. 6 shows a second alternative coupling arrangement 142c. The arrangement 142c comprises a radial drive shaft 352 driven by the low pressure shaft 138 via a first bevel gear arrangement 354. An electrical generator 392 is driven by the drive shaft 352, and provides electrical power to a variable speed electric motor 394 via an electrical interconnector 396. The variable speed motor 394 is in turn mechanically coupled to the high pressure shaft 140 via a shaft 372 and bevel gear arrangement 374. Consequently, power from the low pressure shaft 138 can be transferred to the high pressure shaft 140 via the coupling arrangement 142c.

FIG. 3 shows an alternative gas turbine engine in accordance with the present invention. The engine 200 again comprises a low pressure fan 214 and a high pressure compressor 216. The high pressure compressor 216 is driven by a high pressure turbine comprising first 220 and second 221 stages. The low pressure fan 214 is driven by a low pressure turbine comprising first 222 and second 226 stages. The airflow through the high pressure compressor 216 and turbine stages 220, 221, 222, 226 defines a core flow path. A first combustor 218 is provided in the core flow path between the high pressure compressor 216 and the first stage 220 of the high pressure turbine. A re-heat combustor 224 is provided in the core flow path between the first and second stages 220, 221 of the high pressure turbine. A further reheat combustor 230 is provided in the core flow path between the first 222 and second 226 stages of the low pressure turbine. Further low pressure turbine stages (not shown) may optionally be provided downstream of the second stage of the low pressure turbine 226. Again, the shafts 238, 240 are interconnected by a shaft coupling arrangement 140, such as the arrangements 140a, 140b or 140c described above.

The airflow that flows through the fan 214 but not the compressor 216 or turbines 220, 221, 222, 226 defines a bypass flow path, which is defined by a nacelle 234. A duct burner combustor 231 is located in the bypass flow path, downstream of the fan 214. Each of the first, second and afterburner combustors 218, 224, 230 may be of a conventional type suitable for use as a core combustor, while the duct burner combustor may be of a type suitable for use as an afterburner combustor. Downstream of both the duct burner combustor 232 and the second stage 226 of the low pressure turbine is a mixing duct 228, configured to mix the core and bypass streams. The engine terminates in a nozzle 232, which is configured to expel core and bypass flows to generate thrust.

In view of the provision of a fourth combustor in the bypass duct, a high specific thrust engine can be provided, while having a relatively short engine length.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

For example, the afterburner and/or duct burner combustors may be eliminated. The fan could be a single stage fan, comprising a single rotor and stator.

1. An aircraft gas turbine engine comprising a high pressure compressor driven by a high pressure turbine via a high pressure shaft, a first combustor provided downstream of the high pressure compressor and upstream of the high pressure turbine, a low pressure compressor driven by a low pressure turbine via a low pressure shaft, the low pressure compressor being configured to provide air to the high pressure compressor and to a bypass flow, the low pressure turbine comprising at least first and second turbine stages, and a second combustor provided downstream of the first stage of the low pressure turbine and upstream of the second stage of the low pressure turbine, wherein the gas turbine engine comprises a shaft coupling arrangement configured to transfer power between the high and low pressure shafts.

2. A gas turbine engine according to claim 1, wherein he engine comprises a bypass ratio greater than 1, and may comprise a bypass ratio of approximately 3.

3. A gas turbine engine according to claim 1, wherein the low pressure compressor comprised at least one fan stage configured to provide air to the high pressure compressor and the bypass.

4. A gas turbine engine according to claim 1, wherein the engine comprises an afterburner provided downstream of the low pressure turbine in the core flow.

5. A gas turbine engine according to claim 1, wherein the engine comprises a duct burner located in the bypass, downstream of the low pressure compressor.

6. A gas turbine engine according to claim 1, wherein the engine comprises a mixer configured to mix bypass and core flows downstream of the low pressure compressor and the low pressure turbine.

7. A gas turbine according to claim 6, wherein the mixer is provided upstream of the afterburner.

8. A gas turbine engine according to claim 1, wherein the engine comprises a variable area exhaust nozzle downstream of the low pressure turbine.

9. A gas turbine engine according to claim 1, wherein the coupling arrangement comprises one or more of a fluid coupling such as a torque converter comprising an input shaft coupled to the one of the high pressure shaft and the low pressure shaft and an output shaft coupled to the other shaft, a mechanical clutch and/or a continuously variable transmission or a gearbox having a plurality of discrete ratios, and an electric generator coupled to one of the high and low pressure shafts, and an electric motor coupled to the other shaft, the electric generator being electrically coupled to the electric motor to thereby drive the electric motor.

10. A gas turbine engine according to claim 9, wherein the fluid coupling comprises a first rotor coupled to the input shaft and a second rotor coupled to the output shaft, the first and second rotors being immersed in a transmission fluid within a fluid coupling housing.

11. A gas turbine according to claim 4, wherein the mixer is provided upstream of the afterburner.
